(19) United States
(12) Patent Application Publication
(10) Pub. No.: US 2015/0346136 A1
(43) Pub. Date: Dec. 3, 2015

(54) LIQUID SENSOR

(71) Applicant: Aisan Kogyo Kabushiki Kaisha, Obu-shi (JP)

(72) Inventor: Nobuhiro Kato, Tokai-shi (JP)

(21) Appl. No.: 14/721,515

(22) Filed: May 26, 2015

(30) Foreign Application Priority Data
May 29, 2014 (JP) 2014-111709

(51) Int. Cl. G01N 27/403

(52) U.S. Cl. CPC G01N 27/403

(57) ABSTRACT

A sensor may be provided with a first electrode having a first opposing surface; a second electrode having a second opposing surface opposing the first opposing surface with an interval in between; an insulator accommodating the first electrode and the second electrode, and contacting a contact surface being a part of a surface of the first electrode other than the first opposing surface, or a part of a surface of the second electrode other than the second opposing surface, or a combination thereof; and a shield electrode surrounding the insulator. The shield electrode may have a third opposing surface opposing the contact surface via the insulator. The third opposing surface may contact the insulator.

### CROSS-REFERENCE TO RELATED APPLICATION

This application claims priority to Japanese Patent Application No. 2014-111709 filed on May 29, 2014, the contents of which are hereby incorporated by reference into the present application.

### TECHNICAL FIELD

The application discloses a liquid sensor configured to detect a property of the liquid in a container.

### DESCRIPTION OF RELATED ART

Japanese Patent Application Publication No. 2007-240262 discloses a liquid surface level sensor that includes first to third electrodes. The first electrode and the second electrode are accommodated in the tubular-shaped third electrode. The first to third electrodes are disposed with a gap in between each other. Liquid is interposed between the first electrode and the second electrode, between the first electrode and the third electrode and between the second electrode and the third electrode. Liquid surfaces of the liquid interposed between the individual electrodes change as a liquid surface of the liquid in a container changes. Consequently, the lengths of the electrodes immersed in the liquid change, and thus capacitances between the individual electrodes change. The liquid surface level sensor uses the capacitances between the individual electrodes to detect the liquid surface. In order to remove effects such as electromagnetic waves acting on the first electrode and the second electrode, the third electrode electrically shields the first electrode and the second electrode.

### SUMMARY

When the capacitance between a first and second electrode is detected, a capacitance (so-called parasitic capacitance) generated between at least one of the first electrode and the second electrode and the third electrode are also detected. Since the parasitic capacitance changes according to the liquid surface, when the capacitance between the first electrode and the second electrode is detected, an error may occur due to the change in the parasitic capacitance.

In the present specification, a technology is provided that can reduce detection error caused by a change in parasitic capacitance between an electrode for detection and an electrode for shielding.

The application discloses a liquid sensor configured to detect a property of liquid in a container. The sensor may comprise a first electrode having a first opposing surface; a second electrode having a second opposing surface opposing the first opposing surface with an interval in between; an insulator accommodating the first electrode and the second electrode, and contacting a contact surface being a part of a surface of the first electrode other than the first opposing surface, or a part of a surface of the second electrode other than the second opposing surface, or a combination thereof; and a shield electrode surrounding the insulator. The shield electrode may have a third opposing surface opposing the contact surface via the insulator. The third opposing surface may contact the insulator.

In the configuration described above, the insulator is interposed between the contact surface and the third opposing surface. In other words, the insulator is interposed between an electrode (hereinafter referred to as a “specific electrode”), which is one of or both of the first and second electrodes having the contact surface and the shield electrode. With this configuration, the change in the capacitance (that is, the parasitic capacitance) between the specific electrode and the shield electrode caused by the property of the liquid may be reduced. With this configuration, the detection error caused by the change in the parasitic capacitance may be reduced.

### BRIEF DESCRIPTION OF THE DRAWINGS

FIG. 1 shows a configuration in the vicinity of a fuel tank;

FIG. 2 shows a configuration of a sensor unit in a first embodiment;

FIG. 3 shows a cross-sectional view taken along line III-III in FIG. 2;

FIG. 4 shows a configuration of a sensor unit in a second embodiment;

FIG. 5 shows a configuration in the vicinity of a fuel tank in a third embodiment;

FIG. 6 shows a configuration of a sensor unit in a fourth embodiment;

FIG. 7 shows a cross-sectional view taken along line VII-VII in FIG. 6;

FIG. 8 shows a configuration of a sensor unit in a variation of the fourth embodiment;

FIG. 9 shows the configuration of the sensor unit in a variation of the fourth embodiment;

FIG. 10 shows the configuration of the sensor unit in a variation of the fourth embodiment;

FIG. 11 shows the configuration of the sensor unit in a variation;

FIG. 12 shows a cross-sectional view taken along line III-III in FIG. 2 in a variation;

FIG. 13 shows a cross-sectional view taken along line III-III in FIG. 2 in a variation;

FIG. 14 shows a cross-sectional view taken along line III-III in FIG. 2 in a variation;

FIG. 15 shows a cross-sectional view taken along line III-III in FIG. 2 in a variation;

FIG. 16 shows the configuration of the sensor unit in a variation; and

FIG. 17 shows the configuration of the sensor unit in a variation of the fourth embodiment.

### DETAILED DESCRIPTION

Some features of embodiments described herein will be listed. Notably, technical features described herein are each independent technical element, and exhibit technical usefulness thereof solely or in combinations.

(Feature 1)

The insulator may include a lid closing an opening of the container. With this configuration, it is possible to unify the lid that closes the opening of the container with the liquid sensor.

(Feature 2)

The shield electrode may be covered by the insulator. With this configuration, it is possible to prevent the shield electrode from being exposed to the liquid. Consequently, it is possible to reduce the corrosion of the shield electrode.

(Feature 3)

The shield electrode may be grounded via a circuit being different from a circuit configured to detect the property of the liquid using the first electrode and the second electrode. With this configuration, it is possible to increase the flexibility of an electrical wiring for grounding the shield electrode as compared with the configuration in which the shield electrode is grounded via the circuit for detecting the property of the liquid.

(Feature 4)

The first electrode may have a tubular shape. The second electrode may be disposed inside the first electrode. The first opposing surface may be an inner surface of the first electrode. The second opposing surface may be an outer surface of the second electrode. The contact surface may be an outer surface of the first electrode. With this configuration, it is possible to reduce the change in the capacitance (that is, the parasitic capacitance) between the shield electrode and the first electrode caused by the property of the liquid.

Representative, non-limiting examples of the present invention will now be described in further detail with reference to the attached drawings. This detailed description is merely intended to teach a person of skill in the art further details for practicing preferred aspects of the present teachings and is not intended to limit the scope of the invention. Furthermore, each of the additional features and teachings disclosed below may be utilized separately or in conjunction with other features and teachings to provide improved liquid sensor, as well as methods for using and manufacturing the same.

Moreover, combinations of features and steps disclosed in the following detailed description may not be necessary to practice the invention in the broadest sense, and are instead taught merely to particularly describe representative examples of the invention. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims In addition, all value ranges or indications of groups of entities are intended to disclose every possible intermediate value or intermediate entity for the purpose of original written disclosure, as well as for the purpose of restricting the claimed subject matter.

### EMBODIMENT

### First Embodiment

The fuel supply unit 1 of the present embodiment is mounted on a vehicle such as an automobile, and supplies a fuel to an unillustrated engine. The fuel supply unit 1 includes a fuel tank 10, a fuel pump unit 30 and a sensor device 2. In the fuel tank 10, gasoline or a mixture fuel of gasoline and alcohol (for example, ethanol) is stored.

The fuel pump unit 30 includes a low-pressure filter 32, a pump main body 34, a high-pressure filter 36, a reserve cup 20, a pressure regulator 42, a discharge port 12 and a drive circuit 38. The low-pressure filter 32, the pump main body 34, the high-pressure filter 36, the reserve cup 20 and the pressure regulator 42 are disposed within the fuel tank 10. The pump main body 34 sucks the fuel within the reserve cup 20 via the low-pressure filter 32 from the suction port 34a of the pump main body 34 and increases the pressure. The pump main body 34 discharges the fuel whose pressure is increased from a discharge port 34b into the case 36a of the high-pressure filter 36.

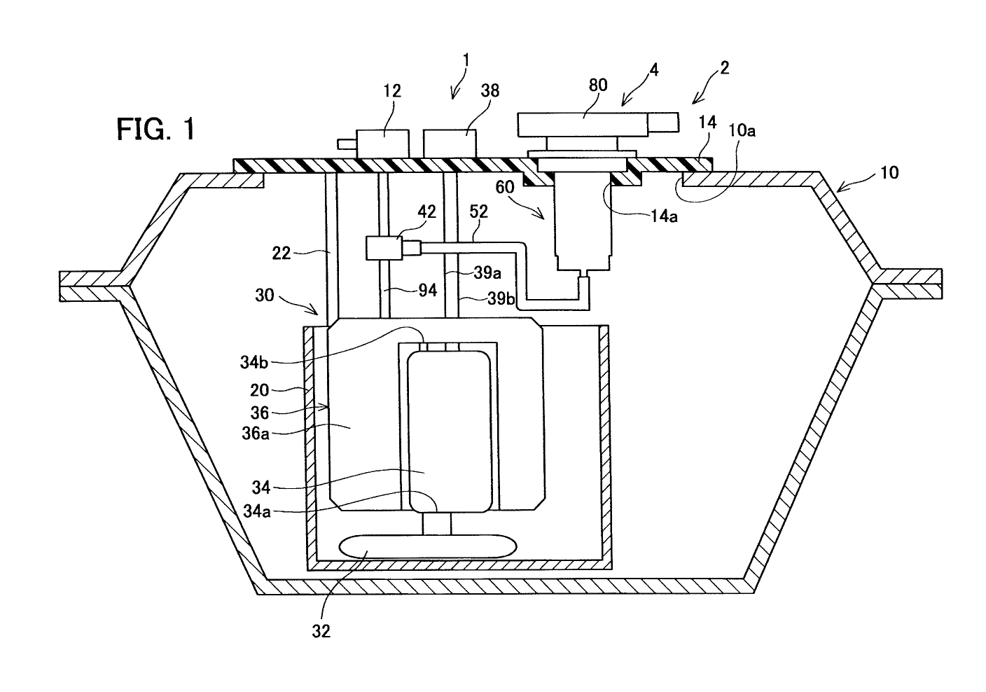

The low-pressure filter 32 is formed of nonwoven fabric into a bag shape. The interior of the low-pressure filter 32 communicates with the suction port 34a of the pump main body 34. The high-pressure filter 36 includes the case 36a and a filter member (not shown). Although not shown in FIG. 1, the case 36a is disposed in the circumferential direction of the pump main body 34. The fuel flowing into the case 36a is filtered by the filter member of the high-pressure filter 36, and is fed out via the suction port 34a to a pipe 94. The pressure regulator 42 is connected to the pipe 94. When the pressure of the fuel within the pipe 94 becomes equal to or more than a predetermined pressure, the pressure regulator 42 discharges excess fuel within the pipe 94 to a pipe 52. In this way, the pressure of the fuel within the pipe 94 is adjusted to be a constant pressure. The fuel within the fuel tank 10 is adjusted to have a constant pressure by the pump main body 34 and the pressure regulator 42 and passes from the pipe 94 through the discharge port 12 and is fed by pressure to the engine.

The pump main body 34, the high-pressure filter 36 and the low-pressure filter 32 are disposed within the reserve cup 20. The reserve cup 20 is fixed by a support column 22 to a set plate 14. By an unillustrated jet pump, fuel outside the reserve cup 20 is fed into the reserve cup 20.

The pump main body 34 is electrically connected to the drive circuit 38 via a conducting wire 39a on the positive side and a conducting wire 39b on the negative side (that is, the ground side). The drive circuit 38 controls a drive signal supplied via the conducting wire 39a to the pump main body 34 to control the pump main body 34.

The sensor device 2 includes a sensor unit 4 and the set plate 14. The set plate 14 closes the opening 10a of the fuel tank 10. The set plate 14 has a disk shape. The discharge port 12, the sensor device 2 and the drive circuit 38 are attached to the set plate 14.

In the set plate 14, an opening 14a is provided. The sensor device 2 is fitted to the opening 14a. Although not shown in the figure, a seal member such as an O-ring may be disposed between the set plate 14 and the sensor device 2.

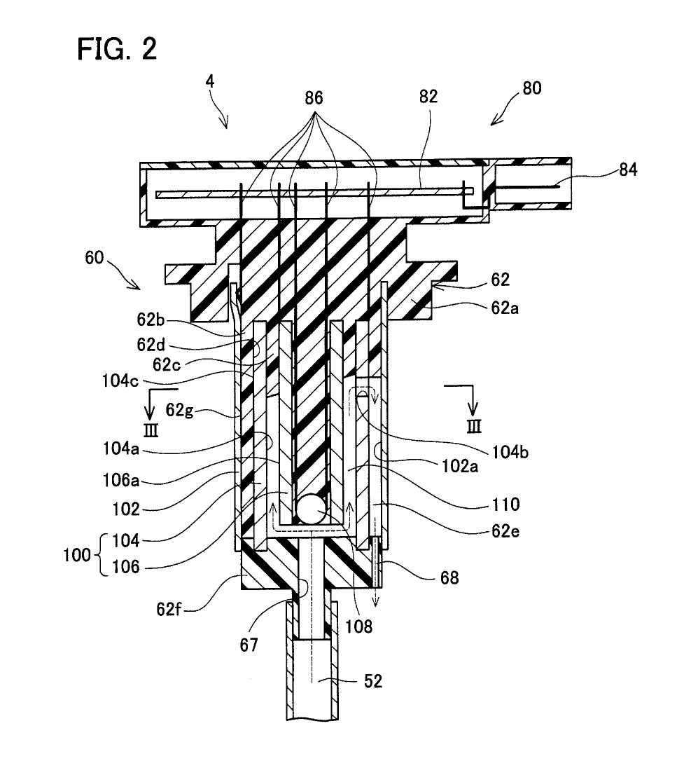

As shown in FIG. 2, the sensor unit 4 includes a liquid quality sensor 60 and a control device 80. The liquid quality sensor 60 includes a case 62, an electrode pair 100, a thermistor 108 and a shield electrode 102. The electrode pair 100 includes an electrode 104 and an electrode 106. Each of the electrodes 104 and 106 is formed of a material having conductivity. The electrode 104 has a cylindrical shape. The center axis of the electrode 104 extends in an up/down direction. In the electrode 104, below the lower end of the upper wall 62a of the case 62, which will be described later, a communication port 104b is formed allowing communication between the inside and outside of electrode 104.

The electrode 106 is disposed inside the electrode 104. The electrode 106 has a cylindrical shape having the same center axis as that of the electrode 104. The length of the electrode 106 in the direction of the center axis is shorter than that of the electrode 104 in the direction of the center axis. The upper end of the electrode 106 is located at the same height as that of the electrode 104, and the lower end of the electrode 106 is located higher than that of the electrode 104. The entire outer surface 106a of the electrode 106 is covered by the electrode 104. The entire outer surface 106a of the electrode 106 is opposed to the inner surface 104a of the electrode 104 with a gap in between. Between the electrode 104 and the electrode 106, a storage space 110 is formed allowing fuel storage.

The thermistor 108 is disposed inside the electrode 106. The thermistor 108 is covered by a resin. The thermistor 108 is disposed at the lower end of the electrode 106.

The electrode pair 100 and the thermistor 108 are accommodated in the case 62. The case 62 is formed of an insulating material. The case 62 is made of a resin. The case 62 includes an upper wall 62a, a side wall 62b and a bottom wall 62f. The upper wall 62a is disposed on the side of the upper end of the electrode pair 100. The upper wall 62a is fitted to the opening 14a of the set plate 14.

At the lower end of the upper wall 62a, an insertion wall 62c that is inserted between the upper end of the electrode 104 and the upper end of the electrode 106 is disposed. The insertion wall 62c is formed integrally with the upper wall 62a. The insertion wall 62c is formed between the electrodes 104 and 106 to have a cylindrical shape. The electrode 106 is fixed to the case 62 in a state where the electrode 106 is inserted into the insertion wall 62c.

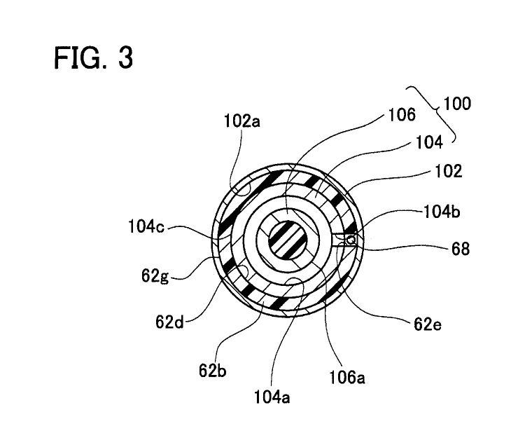

At the lower end of the upper wall 62a, the side wall 62b is formed. As shown in FIG. 3, the side wall 62b has a tubular shape. The side wall 62b is disposed along the outer surface 104c of the electrode 104. The entire inner surface 62d of the side wall 62b is in contact with the outer surface 104c of the electrode 104. In the side wall 62b, a fuel flow path 62e having a slit shape is disposed from the same position as that of the upper end of the communication port 104b of the electrode 104 to the lower end. The fuel flow path 62e extends parallel to the center axis of the electrode 104.

At the lower end of the side wall 62b, the bottom wall 62f is disposed. The bottom wall 62f closes the opening of the lower end of the electrode 104 and the opening of the lower end of the side wall 62b. The electrode 104 is fixed to the case 62 by being supported by the insertion wall 62c, the side wall 62b and the bottom wall 62f. At the center portion of the bottom wall 62f, a flow inlet 67 that communicates with the pipe 52 is formed. At the bottom wall 62f, the pipe 52 is connected so as to communicate with the flow inlet 67. In the bottom wall 62f, a discharge outlet 68 is formed at the lower end of the fuel flow path 62e.

The shield electrode 102 is disposed around the outer surface of the side wall 62b. The shield electrode 102 has a cylindrical shape. The shield electrode 102 is disposed along the outer surface 62g of the side wall 62b. The upper end of the shield electrode 102 is disposed within the upper wall 62a. The entire outer surface 62g of the side wall 62b is in contact with the inner surface 102a of the shield electrode 102. The inner surface 102a of the shield electrode 102 is opposed to the outer surface 104c of the electrode 104 through the side wall 62b. Specifically, the inner surface 102a of the shield electrode 102 is opposed to the outer surface 104c of the electrode 104 through the side wall 62b except the part where the fuel flow path 62e is formed. At the part where the fuel flow path 62e is formed, the inner surface 102a of the shield electrode 102 is opposed to the outer surface 104c of the electrode 104 with an interval in between.

Above the upper wall 62a, the control device 80 is fixed. The control device 80 includes a control circuit 82 and an external terminal 84. The external terminal 84 supplies power to the control circuit 82. On the control circuit 82, a CPU, a memory and the like are mounted. The control circuit 82 is a circuit that uses the liquid quality sensor 60 to detect the temperature of the fuel and the concentration of alcohol.

The control circuit 82 is electrically connected via a plurality of terminals 86 to the electrodes 104 and 106, the shield electrode 102 and the thermistor 108. The control circuit 82 is electrically connected to the shield electrode 102 by being in contact with the terminals 86.

(Operation of the Fuel Supply Unit 1)

When a driver starts the automobile, the fuel supply unit 1 is driven. As shown in FIG. 1, when the fuel supply unit 1 is driven, the drive circuit 38 operates the pump main body 34. Consequently, the fuel within the reserve cup 20 is passed through the low-pressure filter 32 and is sucked into the pump main body 34. The fuel within the pump main body 34 is increased in pressure by impellers within the pump main body 34 and is discharged from the discharge port 34b to the high-pressure filter 36. The fuel is filtered by the filter member of the high-pressure filter 36 and is fed out to the pipe 94. Then, the fuel is supplied from the discharge port 12 to the engine.

When the pressure of the fuel within the pipe 94 becomes equal to or more than a predetermined pressure, the pressure regulator 42 discharges excess fuel within the pipe 94 to the pipe 52. As indicated by a broken arrow in FIG. 2, the fuel within the pipe 52 is passed through the flow inlet 67 and flows into the storage space 110. The fuel flowing into the storage space 110 flows between the electrode 104 and the electrode 106 upward from a lower side. Then, the fuel reaching the upper end of the storage space 110 is passed through the communication port 104b and flows into the fuel flow path 62e. The fuel flowing into the fuel flow path 62e flows through the fuel flow path 62e downward from an upper side, is passed through the discharge outlet 68 and is discharged to the outside of the sensor unit 4.

While the fuel supply unit 1 is being driven, the control circuit 82 uses the electrode pair 100 to detect the concentration of alcohol contained in the fuel. The control circuit 82 repeatedly performs detection of the concentration of alcohol until the engine of the automobile is stopped.

Specifically, the control circuit 82 converts power supplied via the conducting wire 86 from a battery (not shown) into a signal (that is, an alternating current) of a predetermined frequency (for example, 10 Hz to 3 MHz) and supplies it to the electrode 106. The signal supplied to the electrode 106 is returned from the electrode 104 to the control circuit 82. Consequently, charges are stored in the electrode pair 100, and thus a capacitance is produced. The control circuit 82 uses the signal returned from the electrode 104 to the control circuit 82 to calculate the capacitance of the electrode pair 100. Then, the control circuit 82 supplies direct-current power via the conducting wire 86 to the thermistor 108, and detects the temperature of the thermistor 108 from the resistance value of the thermistor 108. The temperature of the thermistor 108 is substantially equal to the temperature of the fuel within the storage space 110. Hence, the control circuit 82 detects the temperature of the thermistor 108, and thereby can detect the temperature of the fuel within the storage space 110.

Since the area between the inner surface 104a of the electrode 104 and the outer surface 106a of the electrode 106 is filled with fuel, the capacitance of the electrode pair 100 is changed according to the dielectric constant of the fuel. Since the dielectric constant of gasoline and the dielectric constant of alcohol significantly differ from each other, the dielectric constant of the fuel is changed by the concentration of alcohol. The dielectric constant of the fuel is also changed according to the temperature of the fuel. In the control circuit 82, a circuit for using the signal supplied to the electrode 106 to specify the capacitance of the electrode pair 100 and a circuit for converting the specified capacitance into the dielectric constant of the fuel are mounted. The control circuit 82 is grounded via the conducting wire 86 to the shield electrode 102.

The signal returned from the electrode 104 to the control circuit 82 is affected by the capacitance (hereinafter referred to as a “parasitic capacitance”) produced between the electrode 104 and the shield electrode 102. Between the electrode 104 and the shield electrode 102, the side wall 62b formed of an insulating material is disposed. Both the outer surface 104c of the electrode 104 and the inner surface 102a of the shield electrode 102 are in contact with the side wall 62b, except the part where the fuel flow path 62e is disposed. Hence, except the part where the fuel flow path 62e is disposed, no fuel is present between the electrode 104 and the shield electrode 102.

In the sensor device 2 described above, parasitic capacitance is produced between the electrode 104 and the shield electrode 102. However, except the part where the fuel flow path 62e is disposed, between the electrode 104 and the shield electrode 102, the side wall 62b, which is the insulator, is present, and no fuel is present. Consequently, the parasitic capacitance is hardly changed by the property (for example, the concentration of alcohol and the temperature) of the fuel. Although in the part where the fuel flow path 62e is disposed, the fuel is present between the electrode 104 and the shield electrode 102, as compared with the entire opposing area of the electrode 104 and the shield electrode 102, the part where the fuel flow path 62e is disposed is small. Hence, the change in the parasitic capacitance caused by the change in the property of the fuel within the fuel flow path 62e is small as compared with the entire parasitic capacitance.

The circuit for specifying the parasitic capacitance of the electrode pair 100 includes a configuration for removing the effects of the parasitic capacitance from the signal returned from the electrode 104 to the control circuit 82. According to the sensor device 2 described above, the parasitic capacitance can be assumed to be a constant value. Hence, it is possible to easily remove the effects of the parasitic capacitance from the signal returned from the electrode 104 to the control circuit 82. According to the sensor device 2 described above, it is possible to reduce a detection error caused by the change in the parasitic capacitance.

Furthermore, in the control circuit 82, a database for calculating the concentration of alcohol in the fuel from the dielectric constant of the fuel and the temperature of the fuel is stored. The database is previously specified by an experiment or an analysis. When the control circuit 82 acquires the signal returned from the electrode 104 to the control circuit 82, the control circuit 82 references the database to detect the concentration of alcohol in the fuel from the dielectric constant of the fuel. The control circuit 82 outputs the detected concentration of alcohol to an ECU (abbreviation of Engine Control Unit). The ECU adjusts the amount of fuel supplied to the engine based on the concentration of alcohol in the fuel.

### Second Embodiment

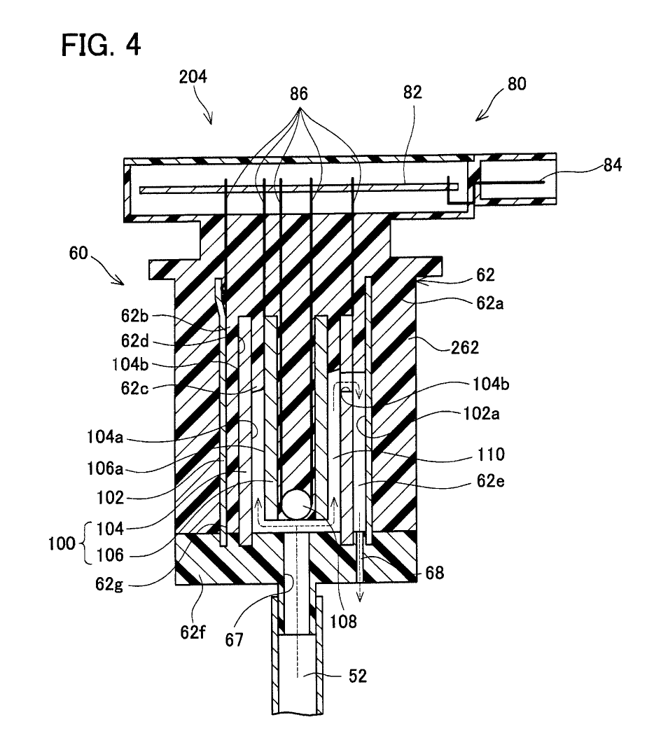

Points different from the first embodiment will be described with reference to FIG. 4. In the second embodiment, the configuration of a sensor unit 204 is different from that of the sensor unit 4 in the first embodiment. In the sensor unit 204, the case 62 further includes an external wall 262 that covers the outer surface of the shield electrode 102. The external wall 262 has a cylindrical shape. The external wall 262 is in contact with the entire outer surface of the shield electrode 102. The bottom wall 62f has the same diameter as the tubular shape of the external wall 262. The other configurations are the same as in the first embodiment. With this configuration, it is possible to achieve the same effects as the first embodiment.

In the sensor unit 204, the entire shield electrode 102 is covered by the external wall 262. Hence, it is possible to prevent the shield electrode 102 from making contact with the fuel. Consequently, it is possible to reduce the corrosion of the shield electrode 102 caused by the fuel.

### Third Embodiment

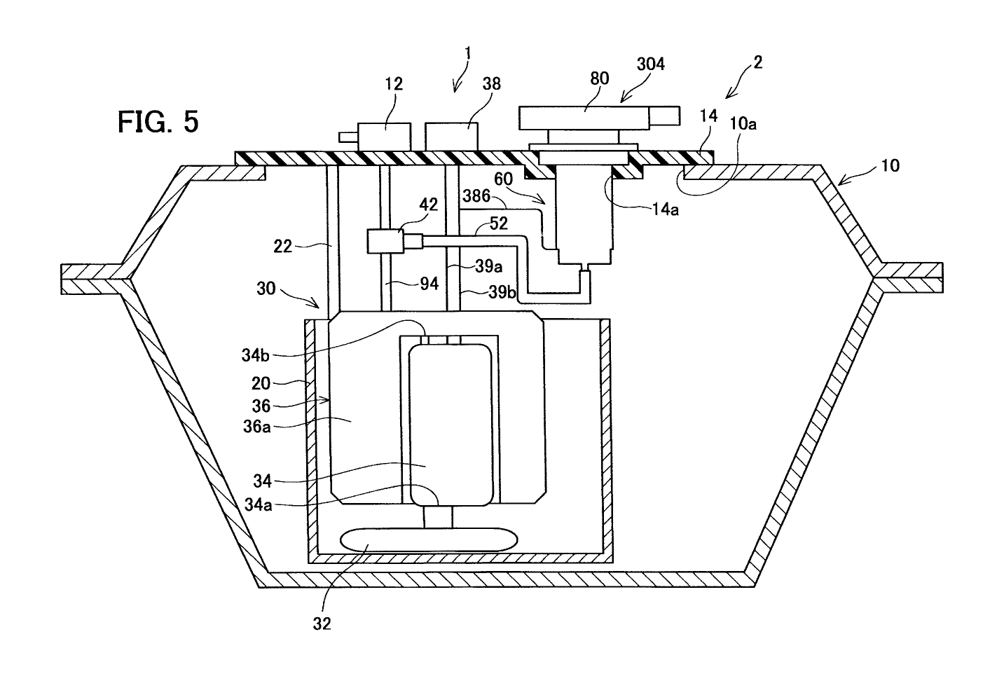

Points different from the first embodiment will be described with reference to FIG. 5. In the third embodiment, the configuration of a sensor unit 304 is different from that of the sensor unit 4 in the first embodiment. In the sensor unit 304, the shield electrode 102 is not electrically connected to the control circuit 82. The shield electrode 102 is connected via a conducting wire 386 to the conducting wire 39b, which electrically connects the pump main body 34 and the drive circuit 38. In this way, the shield electrode 102 is grounded via the drive circuit 38. With this configuration, it is also possible to achieve the same effects as the first embodiment. In this configuration, the shield electrode 102 does not need to be connected to the control circuit 82. The flexibility of the grounding of the shield electrode 102 can be increased. In a variation, regardless of the drive circuit 38, the shield electrode 102 may be grounded via, for example, a center gage (not shown) for detecting the liquid level of the fuel.

### Fourth Embodiment

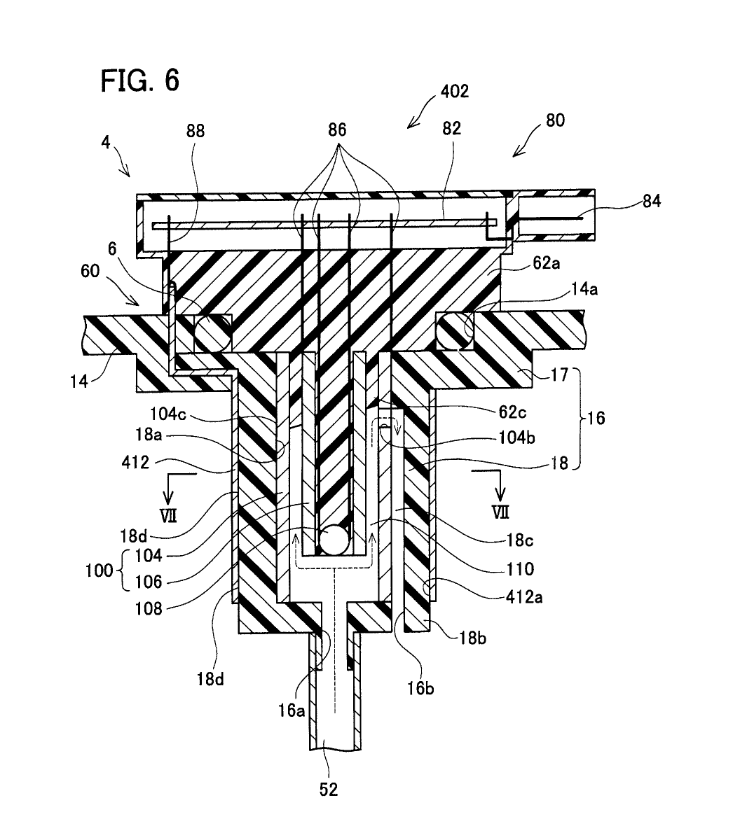

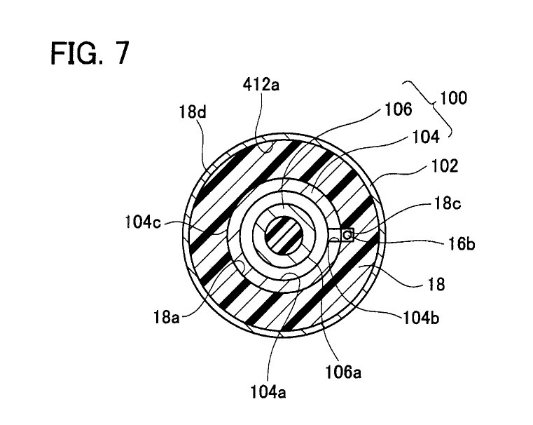

Points different from the first embodiment will be described with reference to FIG. 6. In a fourth embodiment, the configuration of a sensor device 402 is different from that of the sensor device 2 in the first embodiment. In the sensor device 402, a support member 16 that protrudes from the edge of the opening 14a toward the inside of the fuel tank 10 is formed in the set plate 14. The support member 16 includes a press portion 17 and an accommodation portion 18. The press portion 17 has a circular concave portion. In the center portion of the press portion 17, the accommodation portion 18 is formed. The accommodation portion 18 is concaved toward the fuel tank 10 side from the bottom surface of the press portion 17, and has a bottomed cylindrical shape. The accommodation portion 18 is disposed along the outer surface 104c of the electrode 104. The entire inner surface 18a of the accommodation portion 18 is in contact with the outer surface 104c of the electrode 104. In the accommodation portion 18, a fuel flow path 18c having a slit shape is disposed from the same position as that of the upper end of the communication port 104b of the electrode 104 to the lower end. The fuel flow path 18c extends parallel to the center axis of the electrode 104. As shown in FIG. 7, in a part of accommodation portion 18 in the circumferential direction, the fuel flow path 18c is formed in the shape of a groove extending parallel to the axis direction of the electrode 104.

At the lower end portion of the accommodation portion 18, the bottom wall 18b of the accommodation portion 18 is disposed. The bottom wall 18b closes the opening of the lower end of the electrode 104. In the center portion of the bottom wall 18b, a flow inlet 16b that communicates with the pipe 52 is formed. The pipe 52 is connected to the bottom wall 18b so as to communicate with the flow inlet 16b. In the bottom wall 18b, a flow outlet 16b is formed in the lower end of the fuel flow path 18c.

Above the support member 16, the upper wall 62a is disposed. The side wall 62b is not connected to the upper wall 62a. The lower surface of the upper wall 62a is pressed onto the press portion 17. The upper wall 62a is fitted through an O-ring 6 to the press portion 17.

A shield electrode 412 is disposed on the outer surface of the accommodation portion 18. The shield electrode 412 is disposed along the outer surface 18d of the accommodation portion 18. The entire inner surface 412a of the shield electrode 412 is in contact with the outer surface 18d of the accommodation portion 18. The shield electrode 412 is passed through the interior of the press portion 17 to reach the interior of the upper wall 62a. The upper end of a shield electrode 412 is in contact with a conducting wire 88 extending from the control circuit 82. In this way, the shield electrode 412 is electrically connected to the control circuit 82. The other configurations of the shield electrode 412 are the same as the shield electrode 102.

When the fuel supply unit 1 is driven, the fuel within the pipe 52 is passed through a flow inlet 16a and flows into the storage space 110. The fuel flowing into the storage space 110 flows between the electrode 104 and the electrode 106 upward from the lower side. Then, the fuel reaching the upper end of the storage space 110 is passed through the communication port 104b and flows into the fuel flow path 18c. The fuel flowing into the fuel flow path 18c flows through the fuel flow path 18c downward from the upper side, is passed through the discharge outlet 16b and is discharged to the outside of the sensor device 2.

With this configuration, it is also possible to achieve the same effects as the first embodiment. The set plate 14 of the fuel tank 10 can be formed integrally with the sensor unit 4. The pipe 52 is attached to the set plate 14. Hence, when the control circuit 82, the electrode pair 100 or the like is not operated normally, the upper wall 62a is removed from the set plate 14, and thus it is possible to easily remove the control circuit 82 or the like from the fuel tank 10.

### Variations of the Fourth Embodiment

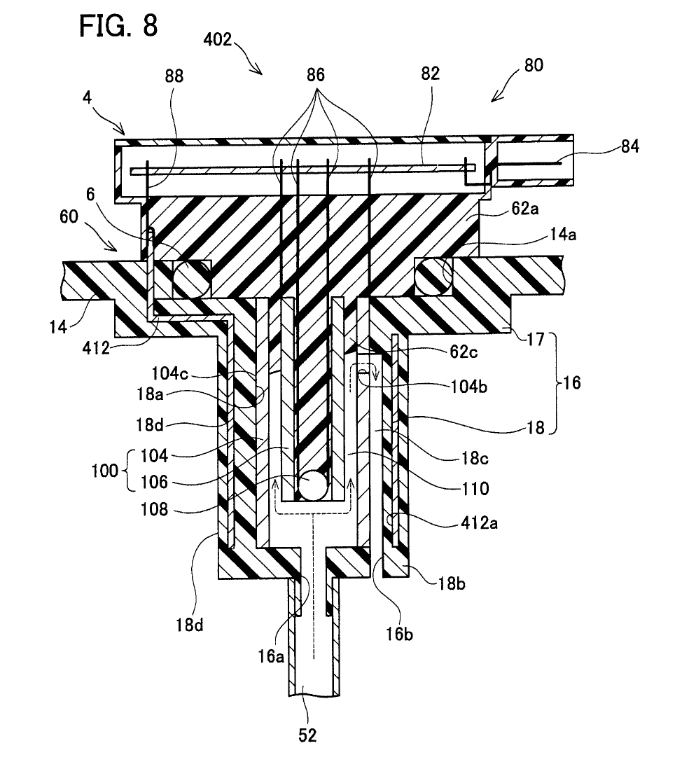

(1) As shown in FIG. 8, the shield electrode 412 may be disposed within the accommodation portion 18. With this configuration, it is possible to prevent the shield electrode 412 from making direct contact with the fuel. In this way, it is possible to reduce the corrosion of the shield electrode 412.

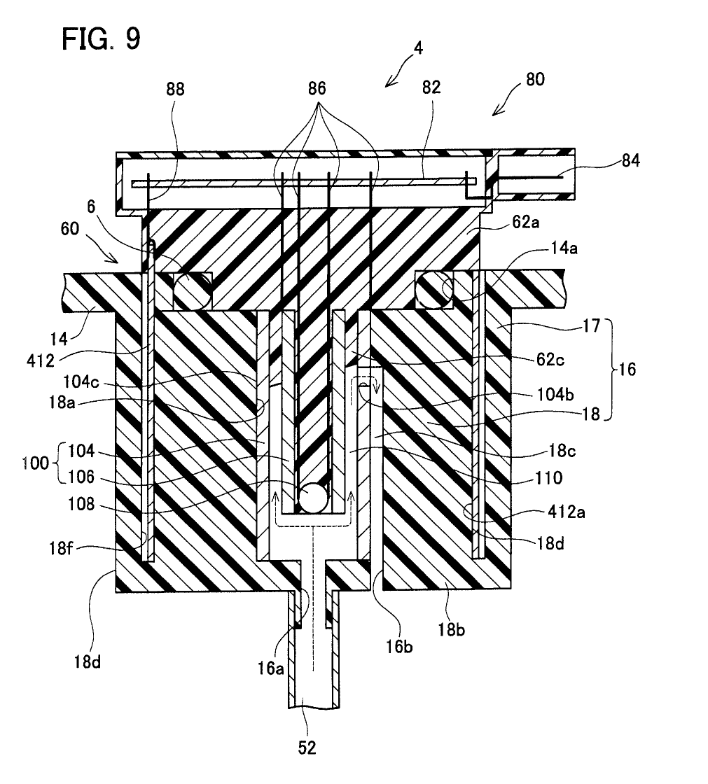

(2) As shown in FIG. 9, the shield electrode 412 may not be bent. The accommodation portion 18 may include a ring-shaped groove 18f that receives the shield electrode 412. The width of the groove 18f may be greater than the length of the plate thickness of the shield electrode 412. The shield electrode 412 may be removably provided in the accommodation portion 18. With this configuration, it is possible to easily remove, while protecting the shield electrode 12 with the accommodation portion 18, the control circuit 82, the electrode pair 100, the shield electrode 412 or the like from the set plate 14.

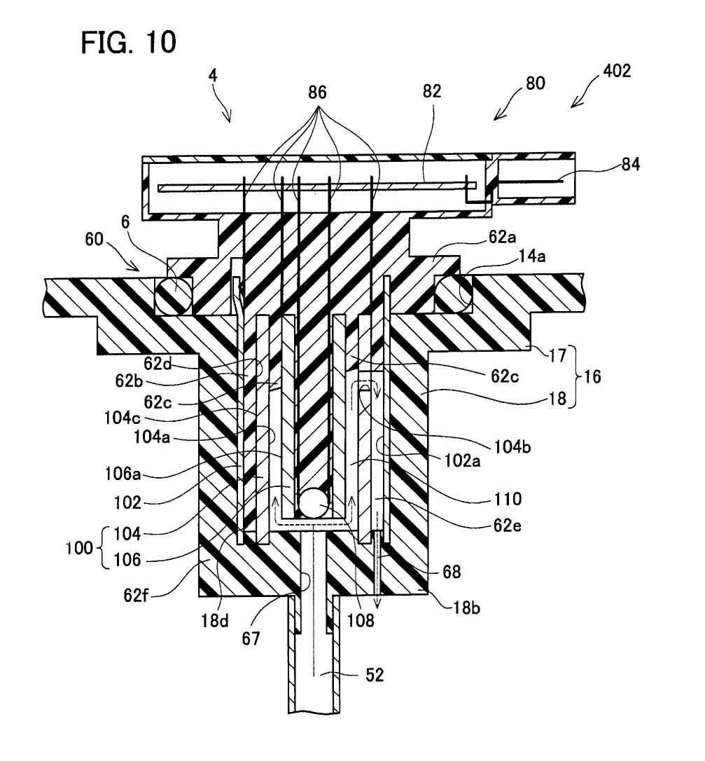

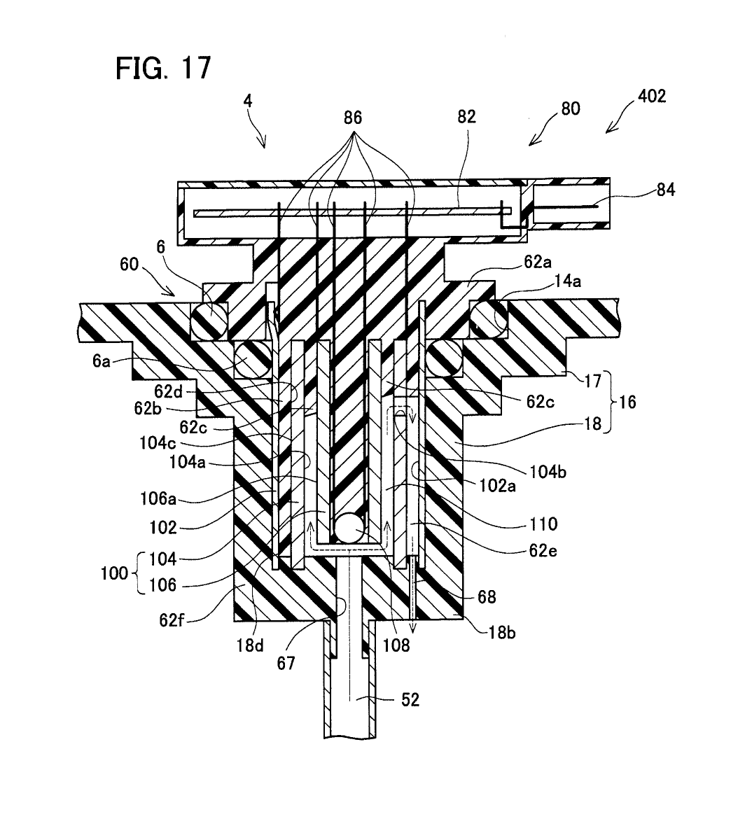

(3) As shown in FIG. 10, in the accommodation portion 18, the electrode pair 100, the shield electrode 102 and the case 62 having the same configuration as in the first embodiment may be disposed. In this case, as shown in FIG. 17, the upper end of the outer surface of the shield electrode 102 may be liquid-tightly sealed with an O-ring 6a. With this configuration, it is possible to reduce, with the two O-rings 6 and 6a, the entrance of liquid such as fuel into the connection part between the shield electrode 102 and the control circuit 82.

(Variations)

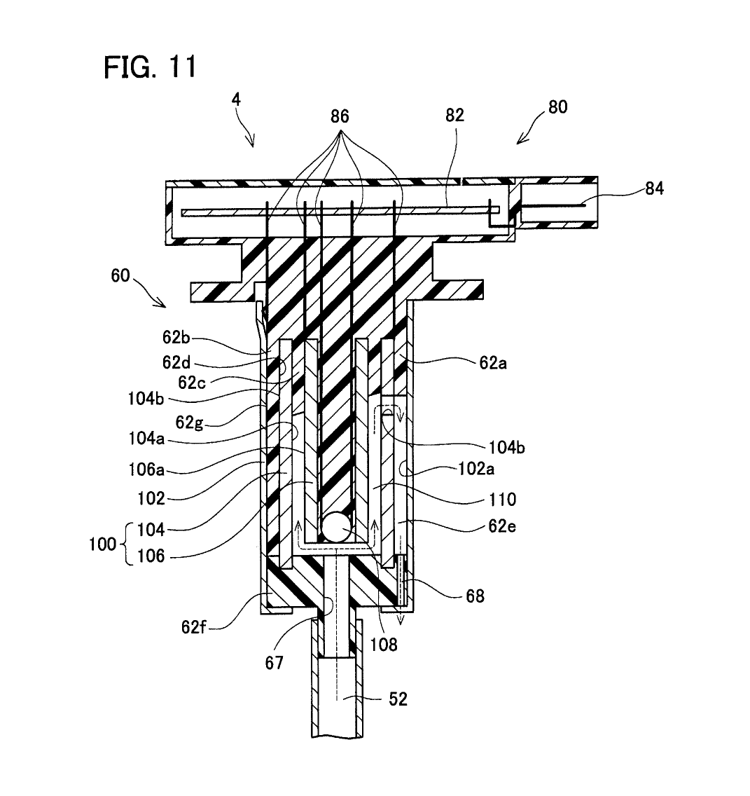

(1) The shape of the shield electrode 102 is not limited to the shapes in the embodiments described above. For example, as shown in FIG. 11, in the shield electrode 102, the lower end of the shield electrode 102 may be bent along the lower surface of the bottom wall 62c to cover the outer edge portion of the bottom wall 62c. The shield electrode 102 may include through-holes continuous to the discharge outlet 68 below the discharge outlet 68. The same is true in the second to fourth embodiments.

The upper wall 62a may have such a shape that the upper end portion of the shield electrode 102 is placed around the outer surface of the upper wall 62a.

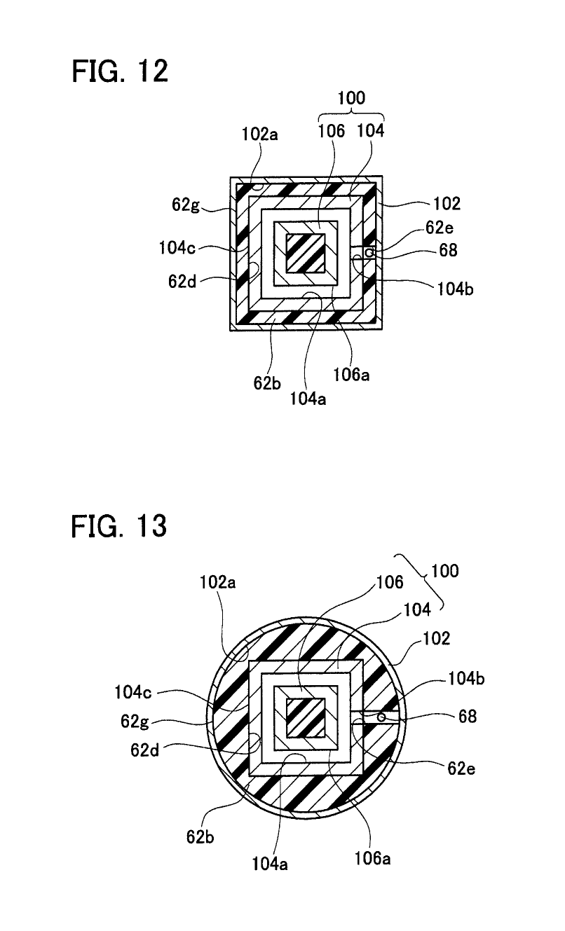

(2) The shapes of the electrodes 104 and 106 are not limited to the cylindrical shape as described in the embodiments discussed above. FIGS. 12 and 13 described above show cross sections having the same height as in FIG. 3. For example, as shown in FIG. 12, in the sensor device 2, the electrodes 104 and 106 may have the tubular shape of a quadrilateral or the tubular shape of a polygon other than a quadrilateral. Furthermore, in addition to the shapes, the electrode 106 may be a solid such as a cylinder or a prism. When the electrodes 104 and 106 have the tubular shape of a polygon, the side wall 62b may have the tubular shape of a polygon according to the shape of the electrode 104. Alternatively, as shown in FIG. 13, in the side wall 62b, the outer surface of the side wall 62b may have a cylindrical shape, and the inner surface of the side wall 62b may have the tubular shape of a polygon.

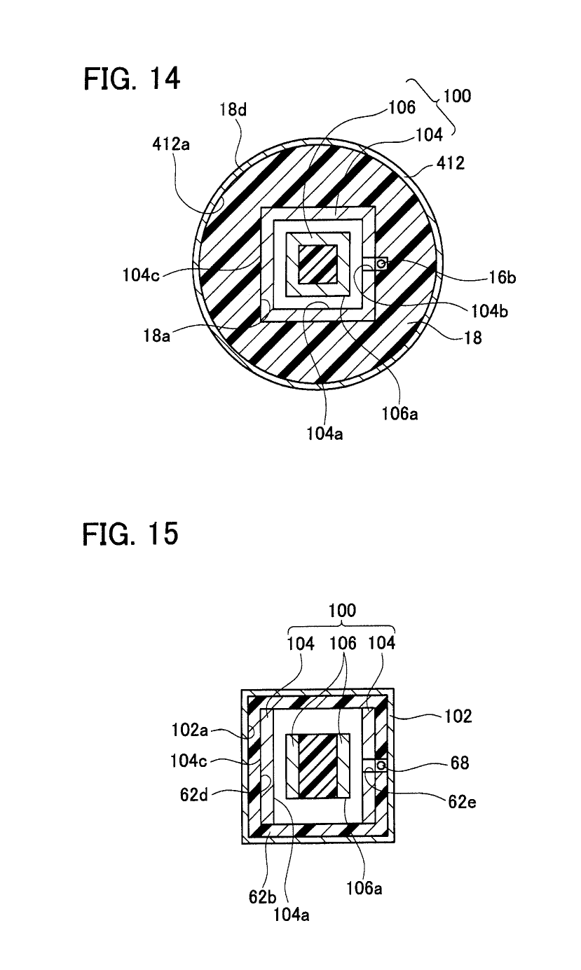

Likewise, for example, as a variation of the fourth embodiment and shown in FIG. 14, in the sensor device 402, the electrodes 104 and 106 may have the tubular shape of a quadrilateral or the tubular shape of a polygon other than a quadrilateral. Furthermore, in addition to the shapes, the electrode 106 may be a solid such as a cylinder or a prism. FIG. 14 shows a cross section having the same height as in FIG. 7.

The electrodes 104 and 106 may have a shape other than a tubular shape. For example, as shown in FIG. 15, in the sensor device 2, the electrodes 104 and 106 may have a flat-plate shape. Specifically, each of the electrodes 104 and 106 may have two flat plates disposed parallel to each other. The two flat plates of the electrode 104 may be opposed to the two flat plates of the electrode 106 with an interval in between.

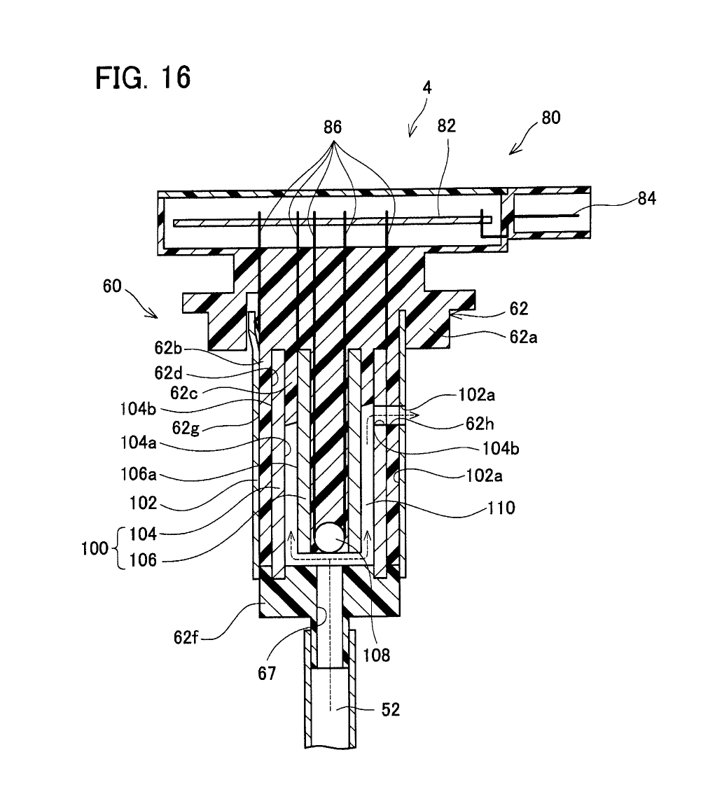

(3) In the first to third embodiments described above, the side wall 62b includes the fuel flow path 62e. However, the side wall 62b may not include the fuel flow path 62e. In this case, for example, as shown in FIG. 16, the side wall 62b may have, on the same axis as the communication port 104b, a discharge outlet 62h that has the same diameter and the same opening shape as the communication port 104b. The shield electrode 102 may have, on the same axis as the communication port 104b and the discharge outlet 62h, a discharge outlet 102b that has the same diameter as the discharge outlet 62h and the communication port 104b. The shapes and the dimensions of the discharge outlet 62h and the discharge outlet 102b are not limited to the shapes and the dimensions described above and, for example, the discharge outlet 62h and the discharge outlet 102b may not have the same diameter as the communication port 104b and may have a different opening shape from the communication port 104b.

In this configuration, the fuel flowing from the communication port 104b is passed through the discharge outlet 62h and the discharge outlet 102b and is discharged to the outside of the sensor device 2. In this configuration, the fuel flow path does not need to be disposed between the electrode 104 and the shield electrode 102. Consequently, it is possible to prevent the parasitic capacitance from being changed by the property of the fuel within the fuel flow path. In the fourth embodiment, likewise, the accommodation portion 18 may not include the fuel flow path 18c.

(4) In the embodiments described above, the sensor device 2 uses the liquid quality sensor 60 to detect the concentration of alcohol in the fuel. However, the sensor device 2 may detect the degree of the degradation of the fuel (for example, the degree of oxidation of the fuel), the liquid level of the fuel or the like.

(5) A “liquid sensor” may be used to detect the property (for example, the degree of degradation, the type of cooling water or the liquid level) of a liquid other than the fuel, for example, cooling water.

(6) In the embodiments described above, the pipe 52 is connected to the pressure regulator 42. However, the pipe 52 may be branched from the pipe 94 or may be connected to the vapor jet of the pump main body 34.

(7) The liquid quality sensor 60 or the like may include two or more electrode pairs.

(8) In the embodiments described above, the control circuit 82 uses the capacitance of each electrode pair, that is, the dielectric constant of the fuel to detect the concentration of alcohol or the like. However, the control circuit 82 may use a value obtained by using an electrode pair other than the capacitance of the electrode pair, for example, the conductivity of the fuel obtained by using the electrode pair to detect the concentration of alcohol.

What is claimed is:

1. A liquid sensor configured to detect a liquid property in a container, the sensor comprising:
a first electrode having a first opposing surface;
a second electrode having a second opposing surface opposing the first opposing surface with an interval in between;
an insulator accommodating the first electrode and the second electrode, and contacting a contact surface being a part of a surface of the first electrode other than the first opposing surface, or a part of a surface of the second electrode other than the second opposing surface, or a combination thereof; and
a shield electrode surrounding the insulator,
wherein the shield electrode has a third opposing surface opposing the contact surface via the insulator, and
the third opposing surface contacts the insulator.

2. The liquid sensor as in claim 1, wherein
the insulator includes a lid closing an opening of the container.

3. The liquid sensor as in claim 2, wherein
the shield electrode is covered by the insulator.

4. The liquid sensor as in claim 1, wherein
the shield electrode is grounded via a circuit being different from a circuit configured to detect the property of the liquid using the first electrode and the second electrode.

5. The liquid sensor as in claim 1, wherein
the first electrode has a tubular shape,
the second electrode is disposed inside the first electrode,
the first opposing surface is an inner surface of the first electrode,
the second opposing surface is an outer surface of the second electrode, and
the contact surface is an outer surface of the first electrode.

6. The liquid sensor as in claim 5, further comprising:
a thermistor configured to detect temperature of the liquid, wherein
the second electrode has a tubular shape, and
the thermistor is disposed inside the second electrode.

7. The liquid sensor as in claim 1, wherein
a thermistor configured to detect temperature of the liquid.

8. The liquid sensor as in claim 1, wherein
the shield electrode is covered by the insulator.
